(19) United States
(12) Patent Application Publication
(10) Pub. No.: US 2026/0362171 A1
(43) Pub. Date: Nov. 12, 2026

(54) METHOD AND APPARATUS FOR ANALYSING SERVICE PERFORMANCE DATA

(71) Applicant: Telefonaktiebolaget LM Ericsson (publ), Stockholm (SE)

(72) Inventors: Xiaohui WANG, Guangzhou (CN); Qian SUN, Guangzhou (CN); Zhijin ZHANG, Guangzhou (CN); Jiehua LIANG, Guangzhou (CN); Junan LU, Guangzhou (CN)

(21) Appl. No.: 19/125,973

(22) PCT Filed: Nov. 10, 2022
(86) PCT No.: PCT/CN2022/131162

§ 371 Date: Apr. 30, 2025

(51) Int. Cl. H04W 24/04; H04L 41/16; H04W 24/08

(52) U.S. Cl. CPC H04W 24/04; H04L 41/16; H04W 24/08

(57) ABSTRACT

Embodiments of the present disclosure provide methods and apparatus for analysing service performance data. The method includes obtaining a plurality of points of data for a key performance indicator, KPI, modelling the plurality of points, with generalized Pareto distribution, GPD, calculating at least one threshold for distinguishing extreme values of the plurality of points, based at least on one or more distribution parameters of the plurality of points and a probability parameter, and determining a plurality of anomaly scores for the plurality of points, based on a comparison of each of the plurality of the points to the at least one threshold. According to exemplary embodiments of the present disclosure, extreme values (which more possibly corresponds to anomaly) will be distinguished more accurately.

### TECHNICAL FIELD

The present disclosure relates generally to the technology of data acquisition and analysis, and in particular, to a method and an apparatus for analysing service performance data.

### BACKGROUND

This section introduces aspects that may facilitate better understanding of the present disclosure. Accordingly, the statements of this section are to be read in this light and are not to be understood as admissions about what is in the prior art or what is not in the prior art.

In computing or communication systems, it is important to monitor the performance of the system, and make maintenance if anomaly happens.

For example, service performance data (such as KPI data) will be obtained to indicate the current performance of the system, and such data will be analysed to determine whether some anomaly happens or will happen.

Usually, the amount of data is large, and it is difficult to presume the distribution characteristics of the data. Thus, it is hard to distinguish or predict the anomaly (especially extreme scenario) of the systems.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Certain aspects of the present disclosure and their embodiments may provide solutions to these or other challenges. There are, proposed herein, various embodiments which address one or more of the issues disclosed herein. Improved methods and apparatuses are provided for analysing service performance data. For example, generalized Pareto distribution may be used to model the data, and thus extreme values (which more possibly corresponds to anomaly) will be distinguished more accurately.

According to a first aspect of the present disclosure, there is provided a method for analysing service performance data. The method comprises: obtaining a plurality of points of data for a key performance indicator, KPI; modelling the plurality of points, with generalized Pareto distribution, GPD; calculating at least one threshold for distinguishing extreme values of the plurality of points, based at least on one or more distribution parameters of the plurality of points and a probability parameter; and determining a plurality of anomaly scores for the plurality of points, based on a comparison of each of the plurality of the points to the at least one threshold.

In exemplary embodiments of the present disclosure, a plurality of values is configured for the probability parameter. The at least one threshold comprises a plurality of thresholds respectively corresponding to the plurality of values of the probability parameter.

In exemplary embodiments of the present disclosure, a plurality of value scope is determined, based on the plurality of thresholds. An anomaly score for a point is determined based on a value scope that the point belongs to.

In exemplary embodiments of the present disclosure, the method may further comprise: adjusting the anomaly score for the point, based on one or more anomaly scores of one or more points around the point.

In exemplary embodiments of the present disclosure, the anomaly score for the point is adjusted, based on a decay factor and a sum of the anomaly scores of one or more points before the point and of the point. The decay factor is determined based on whether an anomaly happens at the point, or the decay factor is determined based on whether an anomaly happens at a point before the point.

In exemplary embodiments of the present disclosure, the decay factor is smaller when an anomaly happens at a point further away from the point.

In exemplary embodiments of the present disclosure, the one or more distribution parameters of the plurality of points are calculated by using maximum likelihood estimation, MLE, and Grimshaw's law.

In exemplary embodiments of the present disclosure, the method may further comprise: summing anomaly scores of points with the same timestamp for more than one KPI in a group, at each timestamp, to obtain a plurality of group anomaly scores for the group.

In exemplary embodiments of the present disclosure, the method may further comprise: creating a sample including one or more groups for a learning machine, each group with a plurality of group anomaly scores. The sample is labelled as a first type or a second type, based on whether an event happens after the sample. The first type is positive, and the second type is negative.

In exemplary embodiments of the present disclosure, the method may further comprise: training the learning machine with a plurality of labelled samples.

In exemplary embodiments of the present disclosure, a first task of the learning machine is trained to predict whether an event will happen after an unlabeled sample; and/or a second task of the learning machine is trained to predict a characteristic parameter of data after the unlabeled sample.

In exemplary embodiments of the present disclosure, the learning machine comprises a neural network.

In exemplary embodiments of the present disclosure, convolutional layers of the learning machine are frozen when training the first task and the second task.

In exemplary embodiments of the present disclosure, a first number of labeled samples with the first type are used to train the learning machine. A first number of labeled samples with the second type are selected from a plurality of labeled samples with the second type, to be used to train the learning machine.

In exemplary embodiments of the present disclosure, scores for ranking of the plurality of labeled samples with the second type are generated, by a one-class support vector method, OCSVM, based on embedding vectors outputted from convolutional layers of the learning machine. The first number of labeled samples with the second type are selected, based on the scores of the plurality of labeled samples with the second type.

In exemplary embodiments of the present disclosure, a distribution scope of the scores of the plurality of labeled samples with the second type is divided into a plurality of sub scopes, based on appearance frequency of the scores. A sub scope covering scores with lower appearance frequencies has a smaller size. The first number of labeled samples with the second type are selected from each sub scope averagely.

In exemplary embodiments of the present disclosure, the service performance data is related to KPI data in algorithmic information technology operations, AIOps, or a sensor acquired data in a monitoring system.

According to a second aspect of the present disclosure, there is provided an apparatus for analysing service performance data. The apparatus comprises: a processor; and a memory, containing instructions executable by the processor. The apparatus is operative for: obtaining a plurality of points of data for a key performance indicator, KPI; modelling the plurality of points, with generalized Pareto distribution, GPD; calculating at least one threshold for distinguishing extreme values of the plurality of points, based at least on one or more distribution parameters of the plurality of points and a probability parameter; and determining a plurality of anomaly scores for the plurality of points, based on a comparison of each of the plurality of the points to the at least one threshold.

In exemplary embodiments of the present disclosure, the apparatus is further operative to perform the method according to any exemplary embodiment of the first aspect.

According to a third aspect of the present disclosure, there is provided a computer-readable storage medium storing instructions which when executed by at least one processor, cause the at least one processor to perform the method according to exemplary embodiment of the first aspect.

Embodiments herein afford many advantages. For example, in embodiments herein, generalized Pareto distribution may be used to model the data, and thus extreme values (which more possibly corresponds to anomaly) will be distinguished more accurately. Further, the data may be raw metrics data (KPI data), and thus the solutions is more scalable and can be widely used in different scenarios and products.

### BRIEF DESCRIPTION OF DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 is a diagram showing an example for service degradation prediction.

FIG. 2A is an exemplary flow chart showing a method for analysing service performance data, according to exemplary embodiments of the present disclosure.

FIG. 2B is an exemplary flow chart showing additional steps of the method as shown in FIG. 2A, according to embodiments of the present disclosure.

FIG. 2C is an exemplary flow chart showing additional steps of the method as shown in FIG. 2A, according to embodiments of the present disclosure.

FIG. 3A is a diagram illustrating an extreme value theory.

FIG. 3B is a diagram showing false alarms by 3 sigma method.

FIG. 3C is a diagram showing how extreme value detection helps to reduce false alarm.

FIG. 4A is a diagram showing 3 thresholds determined by extreme value theory.

FIG. 4B is a diagram showing point-wise anomaly score before being adjusted.

FIG. 4C is a diagram showing point-wise anomaly score after being adjusted.

FIG. 5 is a diagram showing an approach for constructing a group anomaly score.

FIG. 6 is a diagram showing multiple groups, generated by using approach shown in FIG. 5.

FIG. 7 is a diagram showing an approach to slide the observing windows to collect data.

FIG. 8 is a diagram showing a periodic feature of obtained data.

FIG. 9A is a diagram showing a first example about a sample for pretext task.

FIG. 9B is a diagram showing a second example about a sample for pretext task.

FIG. 10 is a diagram showing a multi task learning for multiple tasks.

FIG. 11 shows the network structure for multi-task learning.

FIG. 12 is a diagram showing only the main task for detection.

FIG. 13 is a diagram showing an apply of OneClassSVM.

FIG. 14 is a diagram showing a training for the main task.

FIG. 15 is a diagram showing a successful use case.

FIG. 16A is a diagram showing a first group of exemplary group anomaly score KPI, during an implementation of embodiments of the present disclosure.

FIG. 16B is a diagram showing a second group of exemplary group anomaly score KPI, during an implementation of embodiments of the present disclosure.

FIG. 16C is a diagram showing a 39th group of exemplary group anomaly score KPI, during an implementation of embodiments of the present disclosure.

FIG. 17 is a diagram showing a flowchart for whole service degradation prediction procedure.

FIG. 18 is a block diagram showing exemplary apparatuses suitable for practicing the reception apparatus, according to embodiments of the disclosure.

FIG. 19 is a block diagram showing an apparatus readable storage medium, according to embodiments of the present disclosure.

FIG. 20 is a schematic showing units for the apparatus, according to embodiments of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the term “network” or “communication network” refers to a network following any suitable wireless communication standards. For example, the wireless communication standards may comprise 5^{th} generation (5G), new radio (NR), 4^{th} generation (4G), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. In the following description, the terms “network” and “system” can be used interchangeably. Furthermore, the communications between two devices in the network may be performed according to any suitable communication protocols, including, but not limited to, the wireless communication protocols as defined by a standard organization such as 3rd generation partnership project (3GPP) or the wired communication protocols.

The term “apparatus” used herein may refer to a network device or network entity or network function or any other devices (physical or virtual) in a communication network, namely, a network node/device. For example, the “apparatus” in the network may include a base station (BS), an access point (AP), a multi-cell/multicast coordination entity (MCE), a server node/function (such as a service capability server/application server, SCS/AS, group communication service application server, GCS AS, application function, AF), an exposure node/function (such as a service capability exposure function, SCEF, network exposure function, NEF), a unified data management, UDM, a home subscriber server, HSS, a session management function, SMF, an access and mobility management function, AMF, a mobility management entity, MME, a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the “apparatus” may comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like.

Further, the term “apparatus” may also refer to any suitable function which can be implemented in a network entity (physical or virtual) of a communication network. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), OAM (Operation Administration and Maintenance) etc. In other embodiments, the network function may comprise different types of NFs (such as PCRF (Policy and Charging Rules Function), etc.) for example depending on the specific network.

The term “apparatus” may further refer to any end device that can access a communication network and receive services therefrom, namely, a terminal device. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP, such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and (or) B” should be understood to mean “only A, only B, or both A and B.” The phrase “A and/or B” should be understood to mean “only A, only B, or both A and B.”

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

In any computing or communication networks providing services to customers, service degradation prediction is vital for incident avoidance, which can reduce customers' complain and lengthen the MTBF (Mean Time Between Failure). If the incident can be predicted in advance, NoC (network operation center) & Support team can gain more time to adopt appropriate action such as restarting the VM (virtual machine), enlarging the memory or changing config file to prevent real incident from occurring. And NoC team's KPI (key performance indicator) will be improved dramatically after introducing such feature. It is one of the fundamental problems in AIOps (Algorithmic IT Operations).

Many enterprises provide service level metrics, which reflect the performance of offering services. By predicting the performance metrics degradation status, the users can early detect performance anomaly events, predict service problems, and prevent or even eliminate service downtime, so as to improve product stability and service reliability, improve customer using experience, etc.

For example, Nengwen et al (reference [1]) has proposed a method on this topic. In this paper, they utilize alarm data and introduce a series of feature extraction mechanism and use MIL (multi-instance learning) to train the model. And then employ it to predict incident event.

The paper (reference [1]) mentioned above also introduces the mathematical concept on this topic.

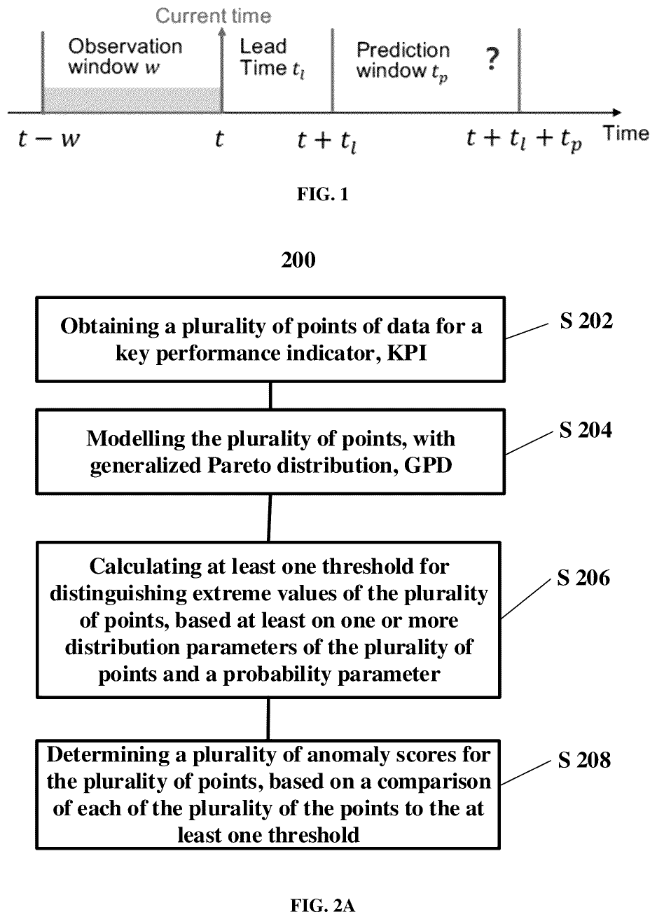

FIG. 1 is a diagram showing an example for service degradation prediction.

As shown in FIG. 1, they formulate the problem of incident prediction as time window classification. They use FIG. 1 to illustrate the problem formulation. To ensure the real-time online prediction, they adopt the strategy of moving time window with size/length w and a fixed step Δt. For the current time t, they get the observation window [t−w, t]. Then, they use alert data within the observation window to predict whether an incident will occur within the prediction window [t+tₗ, t+tₗ+tₚ]. Lead time tₗ in FIG. 1 is the minimum time interval that engineers need to react (e.g., master-standby switch) to an early warning. That is, they can leave enough time for engineers to handle the early warning after predicting an incident.

Some of the problems of these manners, such as described as in Nengwen's paper, are listed as below.

They utilize the alarm data as shown in below table 1. However, in fact, this alarm information is very detailed, and it is hard to be realized in most of the systems. So many systems cannot follow their method.

TABLE 1
The alarm data source from Nengwen's paper

| Time | Content | Server | Service | Severity | Type | Others |
|---|---|---|---|---|---|---|
| 2020 Feb. 3 | Authentication failure | P10 | EPAY | 3 | Network | — |
| 08:24:11 | for SNMP request from host P13. | | | | | |
| 2020 Feb. 3 | Can't get Weblogic | P31 | EPAY | 2 | Middleware | — |
| 08:25:34 | queue (EPAYAPP). Timeout. | | | | | |
| 2020 Feb. 3 | The utilization | P72 | EPAY | 2 | OS | — |
| | of file system | | | | | |
| 08:26:04 | /home/etl441 is 82%, | | | | | |
| | exceeding 80%. | | | | | |
| 2020 Feb. 3 | Business success | P2 | EPAY | 1 | Application | — |
| 08:26:51 | rate is 885, lower than 90%. | | | | | |

Further, many hand-crafted features are proposed, such as alarm count, inter-arrival time. But such feature engineering is tedious and time costing.

The most challenging issue is extreme sample class unbalancing. The positive sample (incident) is quite rare comparing with negative sample (normal). The paper proposes over sampling method, but it usually generate many “fake” samples and it is not very helpful to the result.

The observation time window w is too short. They set 60 min. However, it will miss some important global features. For example, many alarm storm has periodic pattern resulted by software upgrade in certain timestamp in every day/week.

Exemplary embodiments of the present disclosure provide a method and an apparatus for analysing service performance data.

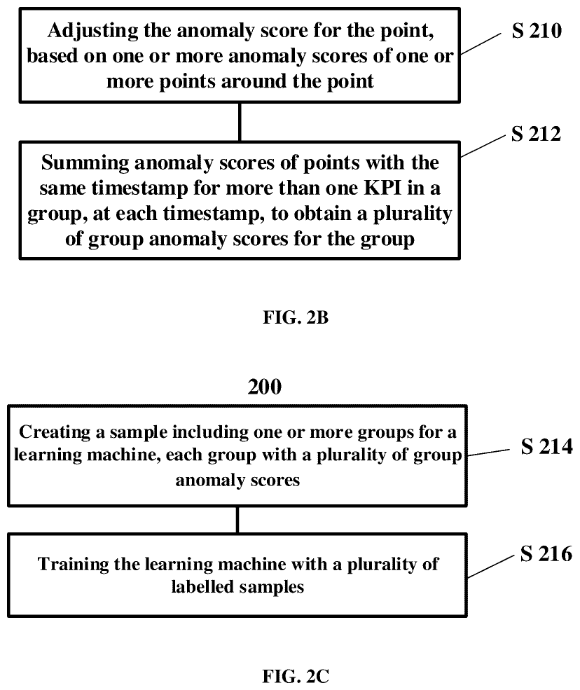

FIG. 2A is an exemplary flow chart showing a method for analysing service performance data, according to exemplary embodiments of the present disclosure.

As shown in FIG. 2A, the method 200 comprises: a step S202, obtaining a plurality of points of data for a key performance indicator, KPI; a step S204, modelling the plurality of points, with generalized Pareto distribution, GPD; a step S206, calculating at least one threshold for distinguishing extreme values of the plurality of points, based at least on one or more distribution parameters of the plurality of points and a probability parameter; and a step S208, determining a plurality of anomaly scores for the plurality of points, based on a comparison of each of the plurality of the points to the at least one threshold.

According to exemplary embodiments of the present disclosure, the generalized Pareto distribution (GPD) may be used to model the data, and thus extreme values (which more possibly corresponds to anomaly) will be distinguished more accurately. Further, the data may be raw metrics data (KPI data), and thus the solutions is more scalable and can be widely used in different scenarios and products.

In exemplary embodiments of the present disclosure, a plurality of values is configured for the probability parameter. The at least one threshold comprises a plurality of thresholds respectively corresponding to the plurality of values of the probability parameter.

In exemplary embodiments of the present disclosure, a plurality of value scope is determined, based on the plurality of thresholds. An anomaly score for a point is determined based on a value scope that the point belongs to.

According to exemplary embodiments of the present disclosure, an anomaly score with a plurality of values may be used. And thus, the anomaly grade of the data point may be more accurately presented.

FIG. 2B is an exemplary flow chart showing additional steps of the method as shown in FIG. 2A, according to embodiments of the present disclosure.

As shown in FIG. 2B, the method 200 may further comprise: a step S210, adjusting the anomaly score for the point, based on one or more anomaly scores of one or more points around the point.

In exemplary embodiments of the present disclosure, the anomaly score for the point is adjusted, based on a decay factor and a sum of the anomaly scores of one or more points before the point and of the point. The decay factor is determined based on whether an anomaly happens at the point, or the decay factor is determined based on whether an anomaly happens at a point before the point.

In exemplary embodiments of the present disclosure, the decay factor is smaller when an anomaly happens at a point further away from the point.

According to exemplary embodiments of the present disclosure, the adjusted anomaly score may be related to a duration of an anomaly over more than one points. That is, a continuing anomaly may be focused more.

In exemplary embodiments of the present disclosure, the one or more distribution parameters of the plurality of points are calculated by using maximum likelihood estimation, MLE, and Grimshaw's law.

According to exemplary embodiments of the present disclosure, an extreme value theory is used, and thus, extreme anomaly will be focused more, which is more important in most of systems.

As shown in FIG. 2B, the method 200 may further comprise: a step S212, summing anomaly scores of points with the same timestamp for more than one KPI in a group, at each timestamp, to obtain a plurality of group anomaly scores for the group.

According to exemplary embodiments of the present disclosure, more than one KPI which is grouped may be analyzed together. The situation of the service performance may be analyzed or predicted more accurately.

FIG. 2C is an exemplary flow chart showing additional steps of the method as shown in FIG. 2A, according to embodiments of the present disclosure.

In exemplary embodiments of the present disclosure, the method may further comprise: a step S214, creating a sample including one or more groups for a learning machine, each group with a plurality of group anomaly scores. The sample is labelled as a first type or a second type, based on whether an event happens after the sample. The first type is positive, and the second type is negative.

In exemplary embodiments of the present disclosure, the method may further comprise: a step S216, training the learning machine with a plurality of labelled samples.

According to exemplary embodiments of the present disclosure, leaning machine may be used to classify that the data representing the current situation of the system is related to an event (such as a future incident of the system) or not.

In exemplary embodiments of the present disclosure, a first task of the learning machine is trained to predict whether an event will happen after an unlabeled sample; and/or a second task of the learning machine is trained to predict a characteristic parameter of data after the unlabeled sample.

According to exemplary embodiments of the present disclosure, a trained learning machine can be used to predict a future event based on the obtained data representing the current situation of the system.

In exemplary embodiments of the present disclosure, the learning machine comprises a neural network.

In exemplary embodiments of the present disclosure, convolutional layers of the learning machine are frozen when training the first task and the second task.

According to exemplary embodiments of the present disclosure, the same sample data may be used for different tasks of the training machine, while the consistence may be remained between different tasks.

In exemplary embodiments of the present disclosure, a first number of labeled samples with the first type are used to train the learning machine. A first number of labeled samples with the second type are selected from a plurality of labeled samples with the second type, to be used to train the learning machine.

In exemplary embodiments of the present disclosure, scores for ranking of the plurality of labeled samples with the second type are generated, by a one-class support vector method, OCSVM, based on embedding vectors outputted from convolutional layers of the learning machine. The first number of labeled samples with the second type are selected, based on the scores of the plurality of labeled samples with the second type.

In exemplary embodiments of the present disclosure, a distribution scope of the scores of the plurality of labeled samples with the second type is divided into a plurality of sub scopes, based on appearance frequency of the scores. A sub scope covering scores with lower appearance frequencies has a smaller size. The first number of labeled samples with the second type are selected from each sub scope averagely.

According to exemplary embodiments of the present disclosure, when selecting the second type samples, which is more than the first type samples, an appearance frequencies (namely, whether this sample is potentially normal or not) is considered. It is tried to select more samples with less appearance frequencies. Therefore, a more accurate leaning machine may be obtained, by using such selected samples.

In exemplary embodiments of the present disclosure, the service performance data is related to KPI data in algorithmic information technology operations, AIOps, or a sensor acquired data in a monitoring system.

According to exemplary embodiments of the present disclosure, the solution can scale to many different scenarios, in which service-related data is obtained and analyzed.

Some more detailed exemplary embodiments will be illustrated below.

For illustration, the solutions in these exemplary embodiments may be divided into 4 parts.

Part 1 is about using Extreme value theory to detect anomalies in data points.

When implementing anomaly detection, a 3-sigma method is widely used. It is very simple. However, the false alarm appearance frequency is very high. In fact, NoC team member usually just pay attention to the extreme scenario. Therefore, 3-sigma method will provide too much useless information.

In order to overcome the shortcoming of 3 sigma method, extreme value theory (such as shown in reference [2]) may be used to detect anomalies in data points. The extreme value theory has no assumption on the data distribution.

For example, by using extreme value theory, 3 thresholds under different parameter value are determined and then point-wise anomaly score and adjusted anomaly score are calculated.

Part 2 is training Sample collection and multi-task construction.

Multi-task learning (such as shown in references [3][4]) is implemented in this solution. It has main task (incident prediction) and auxiliary task or so-called pretext task. The concept is derived from self-supervised learning, which constructs a learning task to improve the performance.

There may be two tasks designed in the model.

Task 1 is main task which is used to predict if incident will happen in next time window. It consists of convolutional layers and full connected layers.

Task 2 is pretext task which is used to predict the highest anomaly score in next time window. It also consists of convolutional layers and full connected layers. The convolutional layers are shared by both 2 tasks.

More specifically, training sample for two tasks are collected as follows.

Part 2a) is for Samples for incident prediction (main task).

In many systems, there're a large number of metrics. Take IoT Accelerator for example, there're about 1 million KPIs.

Usually, each KPI belongs to 1 metrics group which is defined by domain experts.

For each metrics group, the adjusted anomaly score of the KPIs within this group may be summed, and may be named group * anomaly score/group anomaly score.

Suppose there're N_{g} metric groups, the feature of training sample is the N_{g} group anomaly score KPIs. It is a multi-variate time series data. The observing window w may be 4 weeks while the label is whether there's an incident happens in the future 10 min (tₗ)-30 min (tₗ+tₚ). If incident happens, the label for this sample including group anomaly scores will be marked as 1, otherwise, it will be marked as 0. It should be understood these specific parameter values are only used for illustration, and in practice, these values can be changed due to implementation scenarios.

Part 2b) is for Samples for pretext task.

The feature of training sample is the same as part 2a). But a pretext task is constructed here. This task is to predict the maximum value in the next 10-30 min of each group anomaly score KPI.

Maximum value in the next 10-30 min in group anomaly score KPI has strong connection with our main task (incident prediction). Adding pretext task can get better feature representation.

Part 3 is training phase.

In part 2, a multi-task neural network model is introduced. Two tasks are trained at the same time.

After training finish, only task 1 is used to predict service degradation incident. This model is denoted as model T1.

Usually, the positive sample (incident happens) has few samples while there are many negative samples (no incident happens). It is an extreme imbalance scenario which causes low performance of the model. Following approaches are adopted in model training to improve the accuracy. We apply the oneClassSVM (such as shown in reference [5]) to the embedding vectors output by convolutional layer and select the normal sample intelligently by normal score to balance the positive and negative sample. The convolutional layer may be frozen and only full connected layer is trained to get better result.

Part 4 is detection phase.

KPI data is coming as streaming format. The 3 thresholds determined by extreme value theory are used to calculate point-wise anomaly score and adjusted anomaly score. Then group anomaly score KPIs are acquired by summing up all the adjusted anomaly score and multiply decay factor alpha within one KPI group. The group anomaly score KPIs of the latest 4 weeks are sent to model T1 to predict incident. It is a multi-variate time series classification. If it is predicted as an incident, NoC team member will be notified by email, SMS, or dashboard so that they can take action to avoid this incident.

That is, in these solutions, extreme value theory is used to calculate point-wise anomaly score and adjusted anomaly score. This process is very fast. Group anomaly score KPI is utilized as feature to predict incident. Pretext task is constructed, and multi-task learning is used to train to get better feature representation.

In these specific exemplary embodiments, it specifies how to handle extreme sample imbalance issue. Freeze the convolutional layers of model T1 to train 2 classes (with incident and without incident) under sample balance condition. And smart way has been proposed to select normal samples.

According to embodiment of the present disclosure, solution just uses raw metrics data instead of the alarm with detailed information. It is more scalable and can be widely used in different kinds of products. Using extreme value theory can be more robust than 3-sigma and meanwhile it can enjoy the high-speed detection as 3-sigma method. Adjusted anomaly score calculation has considered anomaly points intensity and duration simultaneously. Deep learning is used to handle Ng group anomaly score KPIs so that hand-crafted effort can be reduced. Pretext task is added for better learning feature representation. Special method to handle extreme sample imbalance problem is provided, including select the negative samples in smart way.

Further, the above 4 parts will be further illustrated below.

Part 1 is using Extreme value theory to detect anomalies.

When implementing anomaly detection, 3-sigma method might be used. It is very simple. But the false alarm frequency is very high. However, in fact, NoC team members usually just pay attention to the extreme scenario.

In order to overcome the shortcoming of 3 sigma method, extreme value theory is utilized in embodiments, and it can enjoy the high-speed when detection.

The typical extreme value theory POT makes no assumption on the data distribution (such as shown in reference [2]). It uses the GPD (Generalized Pareto Distribution) to model the value over the peak (for example, it can be defined as 2% maximum value).

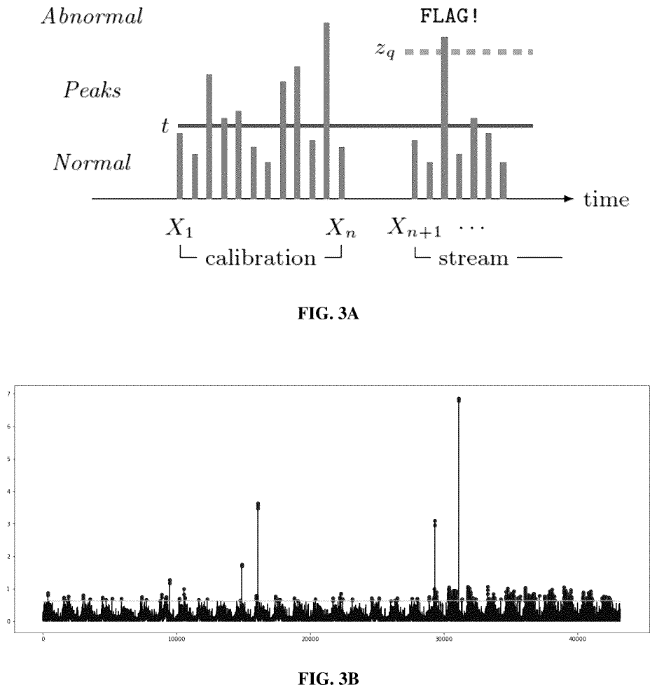

FIG. 3A is a diagram illustrating an extreme value theory.

As shown in FIG. 3A, some data points (X₁, . . . . Xₙ) may be used for calibration. That is, these data points will be used to determine a threshold z_{q}. From the data point Xn+1, a data point will be determined as abnormal (FLAG!), if the data point' value is over the threshold Z_{q}. An initial threshold t may be configured for the calculation for z_{q}. It is useful to the data stream.

Particularly, it uses MLE (Maximum Likelihood Estimation) and Grimshaw's law to get the parameters of the distribution.

A basic formulation may be illustrated as below.

$${z}_{q} ≃ t + \frac{\hat{σ}}{\hat{γ}} ( {( \frac{qn}{{N}_{t}} )}^{- \hat{γ}} - 1 )$$

In this formula, t is the initial threshold. For example, in practice t may be to a high empirical quantile (98%). q is the desired probability. n is the total number of observations, while Nₜ is the number of peaks (whose value is larger than t). γ and σ are 2 learnable distribution characteristic parameters, calculated based on the observations, for example, using Grimshaw's manner. Z_{q} is the final determined threshold for the extreme value.

Once the input parameters (right side of the above formulation) are acquired, the threshold Z_{q} can be determined. Then, if the value of a data point is above threshold, it can be marked as extreme value. It should be noted that anomaly or extreme value may sometimes be mix-used in this disclosure and other papers, for such context.

An exemplary process for calculating the z_{q} may be as follows.
1: start procedure POT (Peaks-over-Threshold) (Xi, . . . . Xₙ, q)
2: t<-SetInitialThreshold (Xi, . . . . Xₙ)
3: Yₜ<-{Xi−t|Xi>t}
4: Ŷ, ô<-GRIMSHAW(Yₜ)
5: Z_{q}<-CalcThreshold (q, \hat{γ}, \hat{σ}, n, Nₜ, t)
6: return Z_{q},t
7: end procedure

As an exemplary implementation, t may be set to 98%. Then, after comparing each data point to the t, a data combination of Yₜ may be obtained. If a data point Xi is bigger than t, then a difference between the data point Xi and t will be included in Yₜ (namely, the GPD distribution is trained in respect with the values over the initial threshold, by POT). Then, a Grimshaw method will be used to generate \hat{γ}, \hat{σ}, based on Yₜ. Further, the Z_{q} can be calculated by the above formulation.

The Grimshaw method is widely used since it can reduce the two variables optimization problem to a single variable equation. And thus the two parameters \hat{γ}, \hat{σ} will be easier to be solved.

Such as illustrated in the reference [2], “The trick of the Grimshaw's procedure is to reduce the two variables optimization problem to a single variable equation. Let us write [symbol] (γ, σ)=log [symbol] (γ, σ). As we find an extremum of [symbol] , we look for solutions of the system. ∇ [symbol] (γ,σ)= [symbol] . Grimshaw has shown that if we get a solution (γ*, σ*) of this system then the variable x*=γ*/σ* is solution of the scalar equation u(x)v(x)=1 where:

$$u ( x ) = \frac{1}{{N}_{i}} {\sum }_{i = 1}^{{N}_{i}} \frac{1}{1 + {xY}_{i}} v ( x ) = 1 + \frac{1}{{N}_{i}} {\sum }_{i = 1}^{{N}_{i}} log ( 1 + {xY}_{i} ) .$$

Moreover, by finding a solution x* of this equation, we can retrieve γ*=v(x*)−1 and σ*=γ*/x*. Nevertheless, the solutions of this equation give only possible candidates for the maximum of [symbol] , so we have to get all the roots, to calculate the corresponding likelihood and keep the best tuple (\hat{γ}, \hat{σ}) as our final estimates. We have to pay attention to how this numerical root search is done. In fact, the values 1+xYi must be strictly positives. As the Yi are positive, we must find

$$x * on ( - \frac{1}{{Y}^{M}} , + ∞ )$$

where YM=max Yi. Grimshaw calculates also an upper-bound x*ₘₐₓ for this root search:

$${x}_{max}^{*} = 2 \frac{\overline{Y} - {Y}^{m}}{{( {Y}^{m} )}^{2}} ,$$

where Ym=min Yi and Y̅ is the mean of the Yi. Finally, the number of roots is not known and 0 is always a solution so the implementation must find all the solutions and pick up those which maximizes the likelihood.”

Here is the result for 3-sigma method and extreme value theory respectively.

FIG. 3B is a diagram showing false alarms by 3 sigma method.

As shown in FIG. 3B, too many alarms (peaks which are flagged by bold dots in FIG.) will be caused.

FIG. 3C is a diagram showing how extreme value detection helps to reduce false alarm.

As shown in FIG. 3C, alarms are greatly reduced. Only these extreme values are flagged.

The solutions in exemplary embodiments may also provide further improvement for implementation of the extreme value theory.

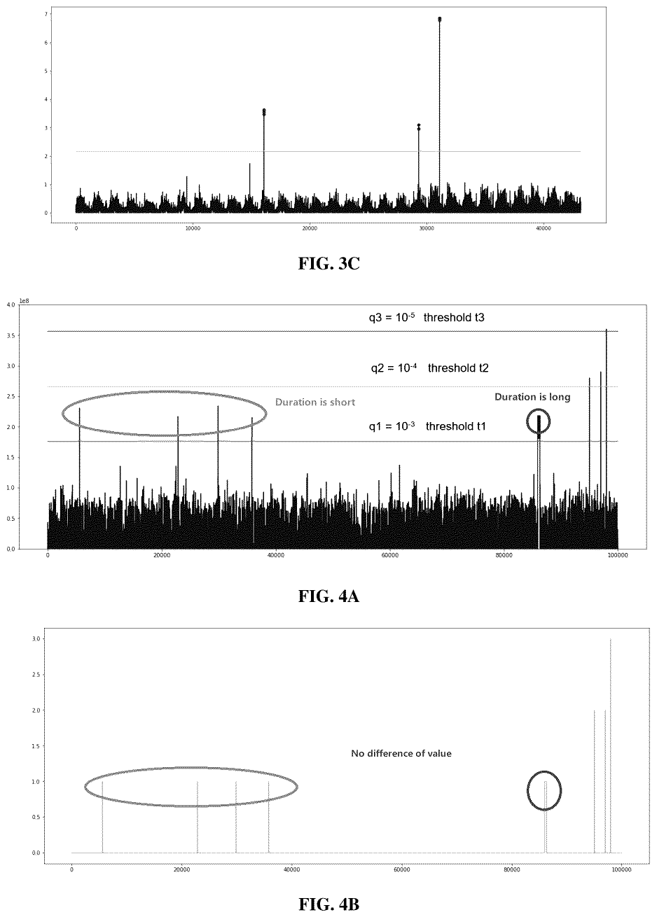

FIG. 4A is a diagram showing 3 thresholds determined by extreme value theory.

FIG. 4B is a diagram showing point-wise anomaly score before being adjusted.

FIG. 4C is a diagram showing point-wise anomaly score after being adjusted.

The extreme value theory only requires to input probability parameter q. The higher q value means the criteria is stricter and more points will be detected as anomalies (while the threshold will be lower), and wise versa. It is recommended to set q from 10⁻³ to 10⁻⁵. The embodiments may set q1=10⁻³, q2=10⁻⁴, q3=10⁻⁵ to get 3 thresholds (such as, t1, t2, t3 in FIG. 4A) and calculate the point-wise anomaly score according to the below table, in which the point value in data point of each timestamp is denoted as v.

TABLE 2
The definition of point-wise anomaly score of each timestamp

| Range | Point-wise anomaly score |
|---|---|
| v < t1 | 0 |
| t1 <= v < t2 | 1 |
| t2 <= v < t3 | 2 |
| v >= t3 | 3 |

The point-wise anomaly score can reflect the anomaly intensity in each timestamp. And the embodiments further use sliding window (e.g., 15 min) to sum up the point-wise anomaly score in this window and multiply decay factor alpha to get adjusted anomaly score.

If there's only 1 anomaly point (take v=1 for example), the point-wise anomaly score value 1 will last for 15 min (e.g., time sliding window is 15 min), without adjustment. It is not reasonable. So, decay factor alpha is introduced.

$$alpha = \{ \begin{matrix}1 & if , anomaly happens at timestamp t \\ {0.8}^{n} & if , no aomaly happen in consecutive n poins\end{matrix}$$

Then adjusted anomaly score is defined as below. Suppose current timestamp is t and the time window length is N while v is the point-wise anomaly score.

$$adjusted anomaly socre = alpha \times {\sum }_{i = t - N + 1}^{t} {v}_{i}$$

In implementation, that may be a streaming process, and the data will come in a data stream. For example, one data point will come every minute. When the data comes, it will be the last point of the sliding window (for example, 15 minutes in length). If the point is an exception (anomaly), add the exception score of the previous 14 points and the exception score of the point itself (that is, the exception score of a total of 15 points). If the point is not an exception, see how many consecutive points in the front are not exceptions. For example, the sliding window has 15 points, and the last 5 points are not exceptions. The n power of 0.8 is taken as 5, which means that if a group of exceptions may have ended, they will be attenuated as soon as possible.

The advantage is that it not only considers the point-wise intensity but also utilizes the duration of the anomalies. If the duration time is long, it needs to be higher alert.

Many warning systems has the function to display the severity level such as Minor, Major, Critical. The KPI adjusted anomaly score can be also set thresholds to distinguish Minor, Major, Critical, and therefore is compatible.

As shown in FIG. 4A, in right side circuited region, anomalies last for a long time while in left side circuited region, anomalies only last for a short time. From point-wise anomaly score perspective, there's no difference between these two regions (See FIG. 4B)). After applying adjusted anomaly score, there's great difference between these two regions (See FIG. 4C)). This is what a practical system needs.

In the cold start of a processing system, historical data is collected from pipeline or data source, for example, from any data collection system, such as Prometheus, Kafka (which are systems widely used in technical field of bigdata), etc., any database and so on. Extreme value theory algorithm is employed for each KPI to acquire 3 thresholds. Then point-wise anomaly score and adjusted anomaly score are calculated. Of course, the thresholds can be updated by day or week to tackle concept drift issue.

As in part 2, training Sample collection and multi-task construction may be illustrated.

Multi-task learning is introduced in solutions in the embodiments. Besides implementing incident prediction, pretext task may be also constructed. The concept is derived from self-supervised learning. It creates a learning task to improve the performance.

In a sub part 2a), samples for incident prediction (main task) are illustrated.

In many systems, there're a large number of metrics. Take IoT Accelerator for example, there're about 1 million KPIs.

Usually, each KPI belongs to 1 metrics group which is defined by domain experts. The number of metrics group varies in different system. It can be denoted as N_{g}. In an exemplary system, there're 39 metrics groups, so N_{g}=39. If there's no metrics group, the KPI can be clustered to generate group, such as according to its name (by using topic model, such as shown in reference [6]). Then each cluster can be considered as one metrics group.

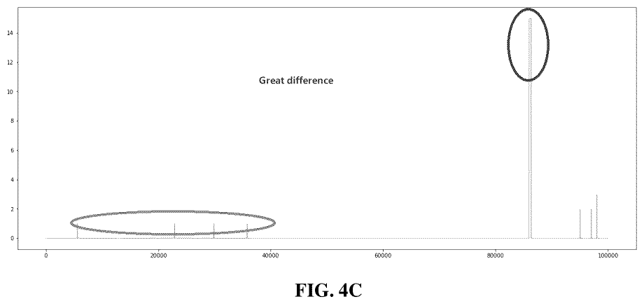

FIG. 5 is a diagram showing an approach for constructing a group anomaly score.

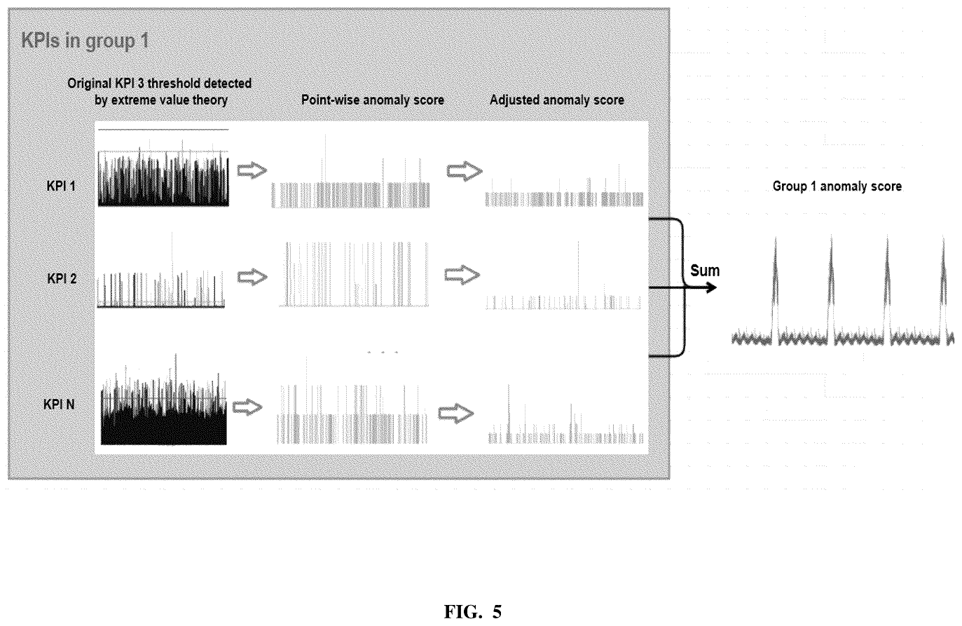

FIG. 6 is a diagram showing multiple groups, generated by using approach shown in FIG. 5.

For each metrics group, the adjusted anomaly score of the KPIs within this group for each timestamp may be summed up to get the new KPI named group * anomaly score (See FIG. 5). There're N_{g} group anomaly score KPIs constructed by this approach (See FIG. 6). It is multi-variate time series data.

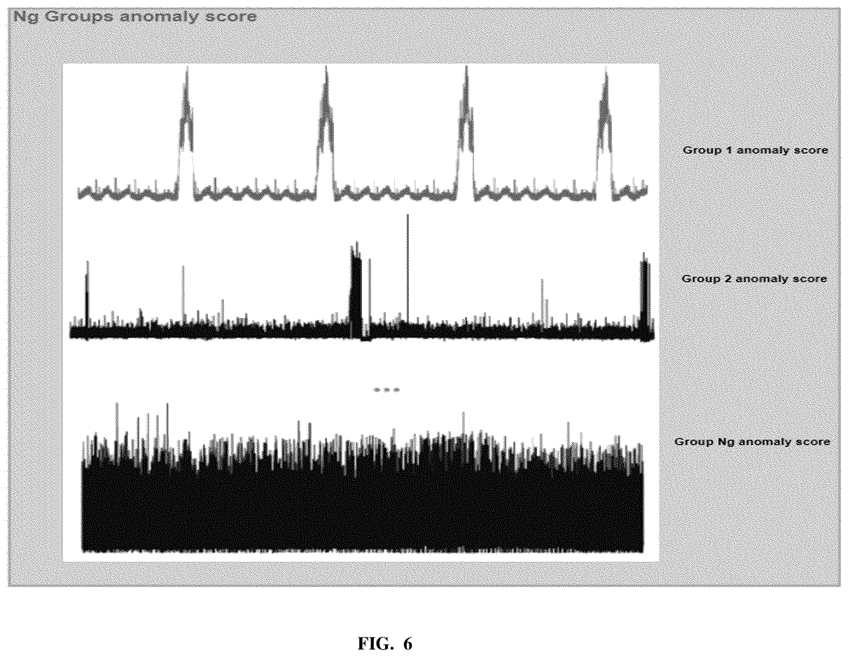

FIG. 7 is a diagram showing an approach to slide the observing windows to collect data.

As showing in FIG. 7, two rectangles (representing the observing windows) are shown. That illustrates that the observing window slides from a first position to a second position.

The observing window w is 4 weeks. Lead time tₗ is defined 10 min and predictive time window tₚ is 20 min.

The feature of training sample is the N_{g} KPIs in the observing window (4 weeks) while the label is whether there's an incident happens in the future 10 min (tₗ)-30 min (tₗ+tₚ). If incident happens, the label will be marked as 1, otherwise, it will be marked as 0. Sliding window is used to keep on collecting samples.

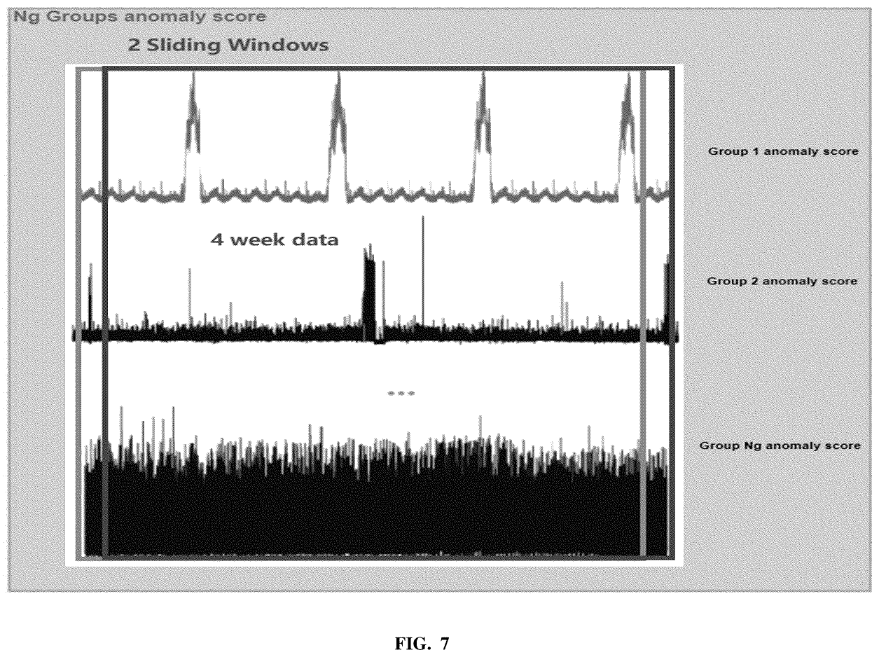

FIG. 8 is a diagram showing a periodic feature of obtained data.

The reason why to collect 4 weeks data is that the group anomaly score KPI may have periodic feature as in FIG. 8. If the sequence is too short, it cannot capture this information.

For calculation, each input group anomaly score KPI may be normalized as the method below:
1) Get the maximum value of the past duration, such as half years, ymax of each group anomaly score KPI.
2) For each point (the value is denoted as v) of each group anomaly score KPI, y=y/ymax. ymax may be denoted as pre-defined maximum value.

The maximum value of the past half years instead of just 4 weeks is used. The reason is that the normalization scale can be unified for all the samples.

In a subpart 2b), samples for pretext task may be illustrated.

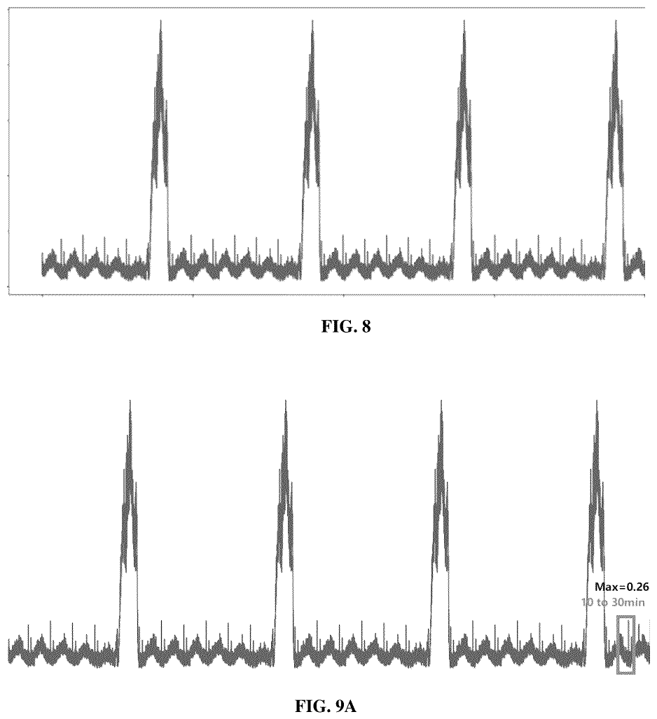

FIG. 9A is a diagram showing a first example about a sample for pretext task.

FIG. 9B is a diagram showing a second example about a sample for pretext task.

The feature of training sample is still the N_{g} group anomaly score KPIs as part 2a) and the normalization method is identical. This pretext task is constructed to predict the maximum value in the next 10-30 min of each group anomaly score KPI. Here is the pretext task illustration. The label is the maximum value (after normalized). In this example, the label is 0.26 (in FIG. 9A) and 0.63 (in FIG. 9B) respectively.

Maximum value in the next 10-30 min in group anomaly score KPI has strong connection with main task (incident prediction). Adding pretext task can get better feature representation.

The main task label incident is usually provided by NoC team (since whether a incident happens may be judged by NoC team) while the pretext task label can be acquired by the group anomaly score KPI itself (since a specific value can be directly calculated based on the data) (self-supervised learning).

Part 3 may be training phase.

A multi-task neural network model may be introduced, and applied in time series data (such as showing in reference [4]).

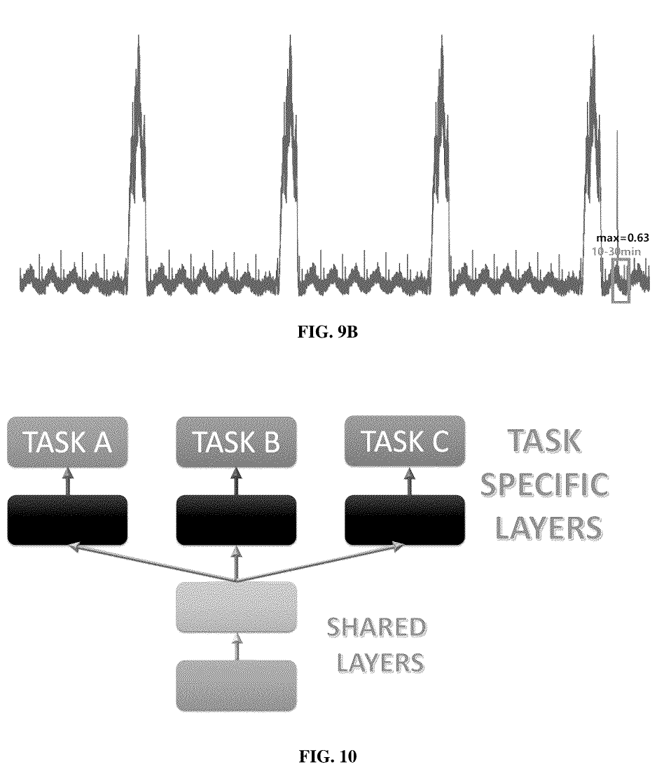

FIG. 10 is a diagram showing a multi task learning for multiple tasks.

Multi-task learning means using one model, here using one neural network, for do simultaneously several tasks (FIG. 10 is also seen in reference [3]).

In this case, for example, it will implement 2 training tasks at the same time.

Task 1 consists of convolutional layers and full connected layers. It is used to predict incident.

Task 2 also consists of convolutional layers and full connected layers. It predicts the labels of pretext task. The convolutional layers are shared by both 2 tasks. Adding pretext task is good for representation learning.

Task 1 is the main task while the task 2 is the pretext task.

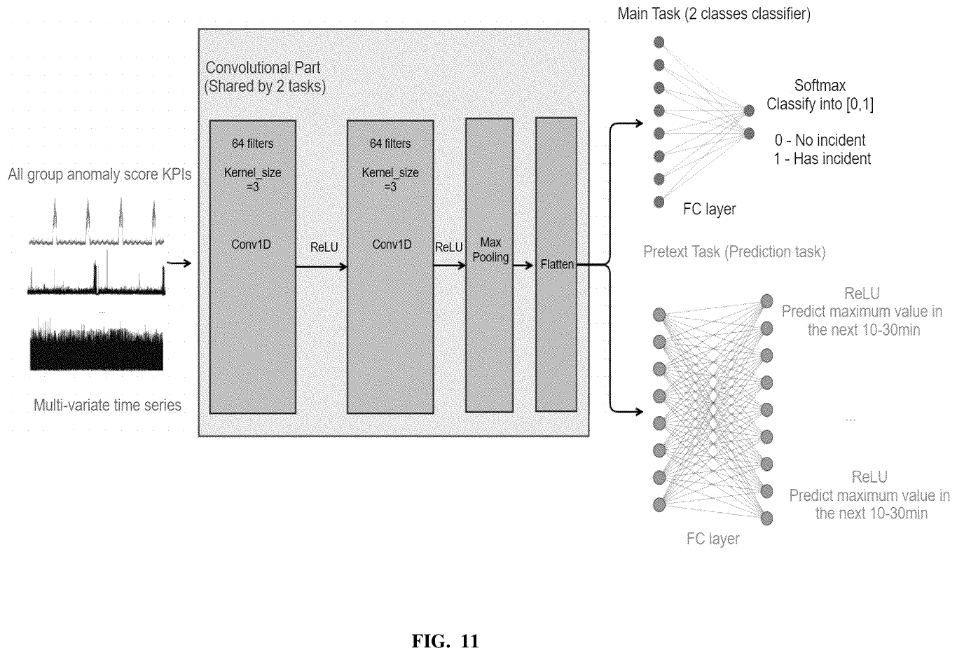

FIG. 11 shows the network structure for multi-task learning.

The neural network of FIG. 11 consists of 2 parts: The shared layers (CNN) and FC (Fully connected layers).

As shown in FIG. 11, the multi-variate time series (including all group anomaly score KPIs) are inputted to the convolutional part of the learning machine. The convolutional part may include a first layer for convolution, a second layer for convolution, max pooling layer, and flatten layer. There are also ReLU (Rectified Linear Unit) between some layers.

Then, the output from the convolutional part will go for different FC (full connect) layers of two tasks.

The main task may be a 2 classes classifier, using a softmax function. A class of 0 may indicate no incident. A class of 1 may indicate incident.

For the pretext task, the reason that ReLU (Rectified Linear Unit) is used at the last output layer instead of sigmoid function in the pretext task is the maximum value in the next 10-30 min may exceed the pre-defined maximum value. It will be larger than 1 after normalization in this scenario.

The input is all the group anomaly score KPIs in 4 weeks. It is multi-variate time series handling.

Specifically, for the CNN (convolutional neural network) structure, the first layer is Conv1D with 64 filters and the kernel size is 3. The ReLU is the activation function for this layer. The second layer is also Conv1D with 64 filters and the kernel size is 3. The ReLU is the activation function. The third layer is the max pooling layer. Finally, the output will be flattened as the input for the FC layers.

There're 2 branches of FC layers for different tasks. The first branch is for main task. It consists of hidden layer with 256 neurons and finally output by softmax activation function to predict 0 or 1. The second branch is for pretext task. It consists of hidden layer with 256 neurons and finally output the prediction for the maximum value of each group anomaly KPI by ReLU activation functions.

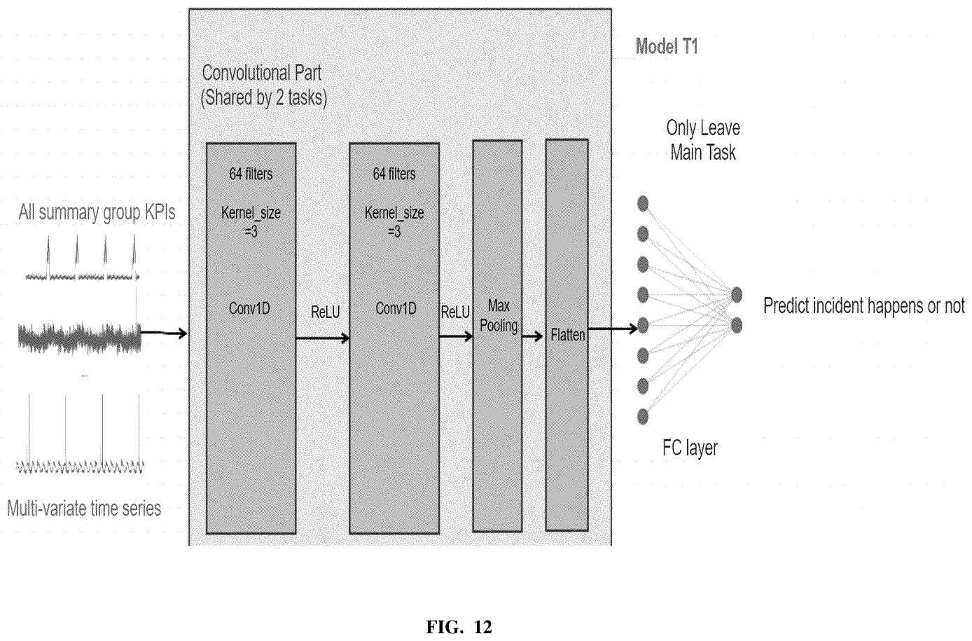

FIG. 12 is a diagram showing only the main task for detection.

After training finishes, only task 1 is used to predict service degradation incident (See FIG. 12). This model may be denoted as model T1.

In the samples for training (such as, the samples already labelled by human), usually, the positive sample (incident happens) has few samples while there are many negative samples (no incident). It is extreme imbalance scenario. There're 2 traditional approaches to solve this problem.
1) Apply pressure test or chaos engineering in the lab to simulate many incident scenarios. But not all the products can implement this operation and incident generated in the lab doesn't necessarily mean it will happen in the customers' practical site.
2) Use machine learning method. There are 3 traditional ways and disadvantages.
   a) Over sample the positive samples. Simply duplicate or just making some noises of positive sample usually generate meaningless samples. It has risk of over-fitting of the positive sample.
   b) Under sample the negative sample. It fails to utilize all the data to get good feature representation and it will under-fit for the whole dataset.
   c) Give very high weight to the negative sample for the training loss. But in practice, it doesn't have good result.

The strategy mentioned below is adopted to re-balance the dataset (see reference [7] for handling long tail image classification).

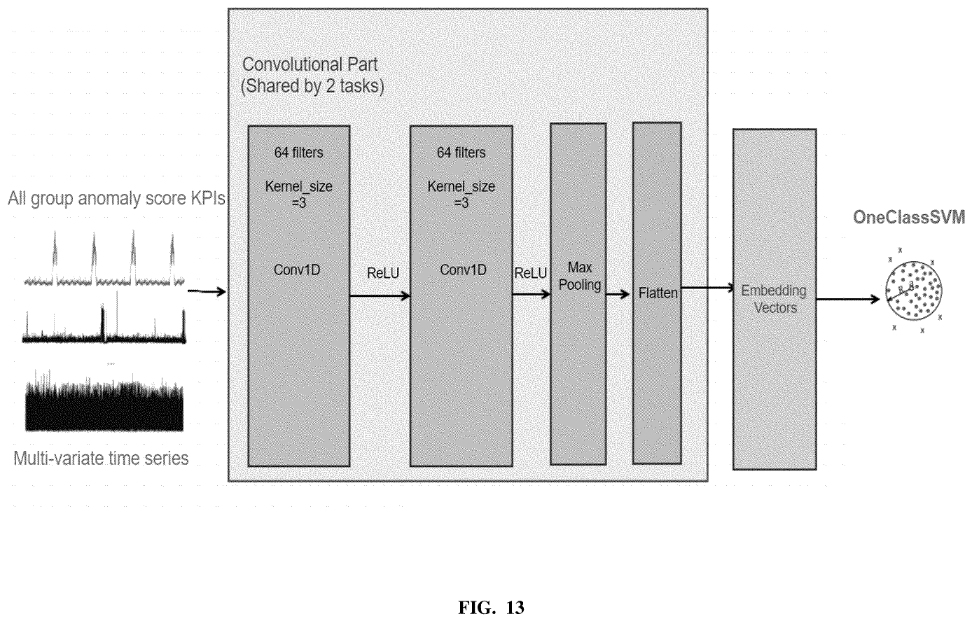

FIG. 13 is a diagram showing an apply of OneClassSVM.

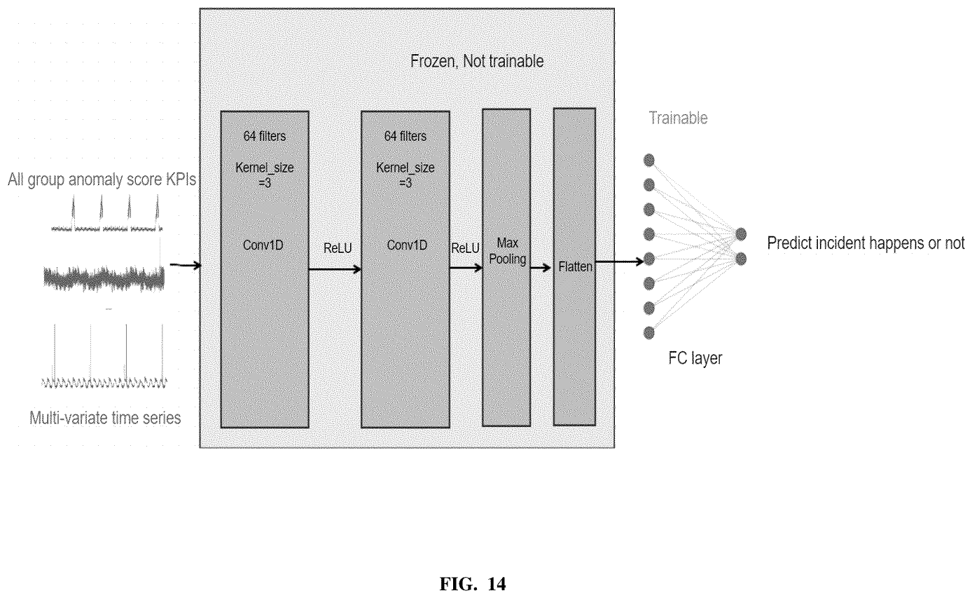

FIG. 14 is a diagram showing a training for the main task.

Suppose the number of positive samples is N, the negative sample is re-sampled to N as below:
i. Input all the negative samples to the neural network of convolutional part already trained. The convolutional part is the same as before. The embedding vectors are outputted from the convolutional layer and are used for a OneClassSVM to get the normal score for each sample, as shown in FIG. 13.
ii. For the normal score output from OneClassSVM, if the score is low, it means the sample is rare. If the score is high, it means the sample happens frequently. The sample is sorted by the normal score from the lowest to highest. Suppose the number of positive samples is N, we sample from the negative sample according to the table below. Accordingly, the samples with low frequency may be also selected equally to the samples with high frequency.

TABLE 3
The sample method to balance positive and negative

| Rank | Sample Number |
|---|---|
| Lowest 2% | N/6 |
| Lowest 2%-5% | N/6 |
| Lowest 5%-10% | N/6 |
| Lowest 10%-20% | N/6 |
| Lowest 20%-40% | N/6 |
| Other | N/6 |

iii. After sampling, the positive and negative sample is 1:1. And the convolutional layer is frozen and only the full connected layer is trained using these 1:1 balance samples. It can overcome sample extreme imbalance issue. See FIG. 14. The model T1 is updated by this step. Further, all the samples have been seen in the multi-task learning. So, it means the whole datasets have been utilized.

Part 4 is Detection phase.

KPI data is coming as streaming format. The 3 thresholds determined by extreme value theory are used to calculate point-wise anomaly score and adjusted anomaly score. Then group anomaly score KPIs are acquired by summing up all the adjusted anomaly score within one KPI group. The group anomaly score KPIs of the latest 4 weeks are sent to model T1 to predict incident. It is a multi-variate time series classification. If it is predicted as an incident, NoC team member will be notified by email, SMS, or dashboard so that they can take action to avoid this incident.

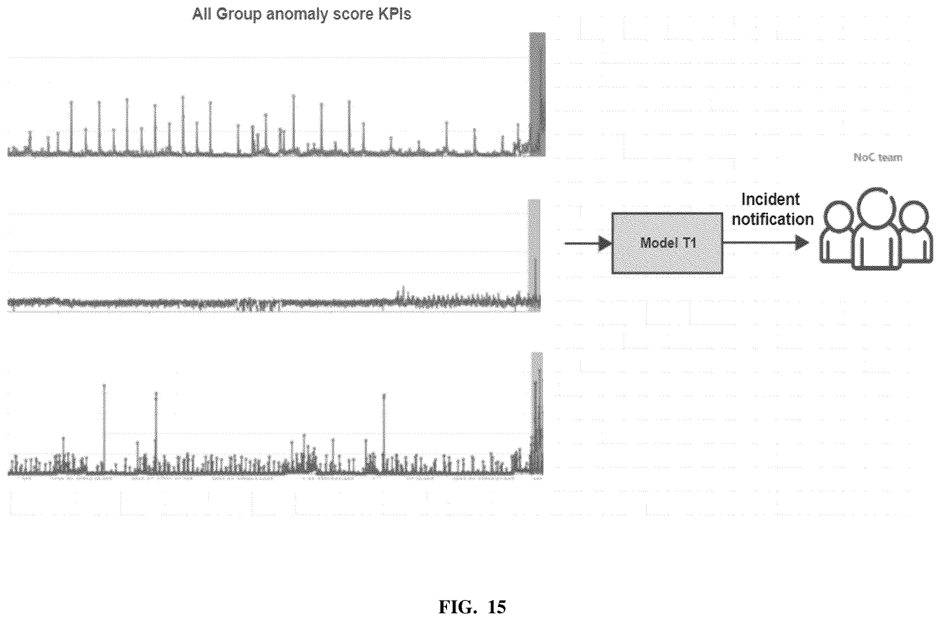

FIG. 15 is a diagram showing a successful use case.

As shown in FIG. 15, on certain time slot in a July, the program according to embodiments of the present disclosure predicts an incident will happen for a customer CSP (Communication Service Provider) A. NoC team has received our incident notification and adopt actions in a lead time to avoid potential issue, which reduces customer's complain.

According to NOC team feedback, without the service prediction, the data base query will be much slower than normal, which will result offering API service not available, and impact the platform reliability and stability. So, after introducing system according to embodiments of the present disclosure, the MTBF (Mean Time Between Failure) is lengthened and ticket number decreases, which can improve NoC team's KPI.

The solution can scale to other scenarios.

Elderly people fall detection is very important in health-care system. Sensors such as X,Y,Z accelerometers are popular used to monitor elderly people status. Multi-task learning as mentioned above may be used to train the model to distinguish fall or not fall. The main task is to classify fall happens or not while the pretext task is to predict the next value of the time series. And the sample balance method and training method can also be employed in this scenario for the fall sample is quite few comparing with normal sample.

Time series anomaly detection is widely used in AIOps. Multi-task learning can be employed in this scenario. Main task is to implement normal or abnormal classification while pretext task is to predict the future point value. It is also extreme imbalance problem since anomaly sample is rare. So, our re-balance method can be introduced in this scenario.

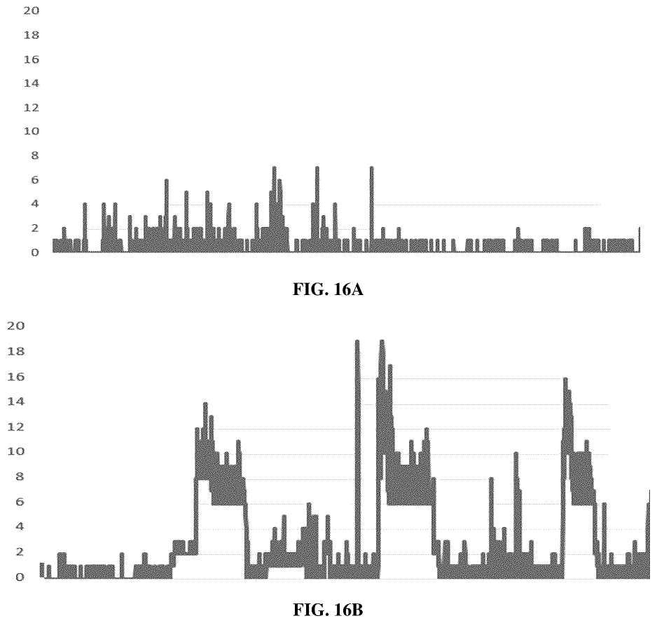

FIG. 16A is a diagram showing a first group of exemplary group anomaly score KPI, during an implementation of embodiments of the present disclosure.

FIG. 16B is a diagram showing a second group of exemplary group anomaly score KPI, during an implementation of embodiments of the present disclosure.

FIG. 16C is a diagram showing a 39th group of exemplary group anomaly score KPI, during an implementation of embodiments of the present disclosure.

During an exemplary implementation, there are about 1 million KPI to handle. And it is divided into 39 KPI groups. The observing window w is 4 weeks. Lead time tₗ is defined 10 min and predictive time window tₚ is 20 min.

KPI data is coming as streaming format. The 3 thresholds determined by extreme value theory are used to calculate point-wise anomaly score and adjusted anomaly score. Then group anomaly score KPIs are acquired by summing up all the adjusted anomaly score within one KPI group. The group anomaly score KPIs of the latest 4 weeks are sent to model T1 to predict incident. It is a multi-variate time series classification. If it is predicted as an incident, NoC team member will be notified by email, SMS, or dashboard so that they can take action to avoid this incident.

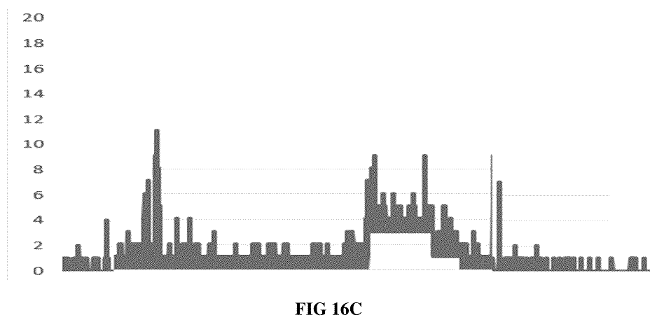

FIG. 17 is a diagram showing a flowchart for whole service degradation prediction procedure.

FIG. 17 shows a whole procedure, and details of each part of FIG. 17 are already illustrated above, such as in FIG. 2 to FIG. 16. As shown in FIG. 17, the model T1 is built up firstly as below.
a) Multi-task learning is implemented. Task 1 (main task, predict incident) and task 2 (pretext task, predict the maximum value in the next 10-30 min within each metric group) are constructed. The model consists of convolutional layers and full connected layers and it is trained to learn 2 tasks at the same time.
b) Only Task 1 branch is left for prediction, namely model T1, but it is under serious label imbalance.
c) In order to balance the positive sample and negative sample, OneClassSVM trained by the embedding vectors (only of negative samples) output from convolutional layer is utilized. Then normal score is calculated for each negative sample. And negative sample is re-sampled according to the ranking of normal score. If the sample is rare, it will have more opportunity to be selected.
d) The model T1 is re-trained under sample balance condition. The convolutional layer is frozen while the FC layers are trainable.
e) Finally, model T1 is used in the real customers' site to predict incident.

According to exemplary embodiments of the present disclosure, extreme values (which more possibly corresponds to anomaly) will be distinguished more accurately, and thus NoC team will be notified more accurately. The NoC team will get accurate alarm about possible incident, and will not be noised by too many “false” alarms.

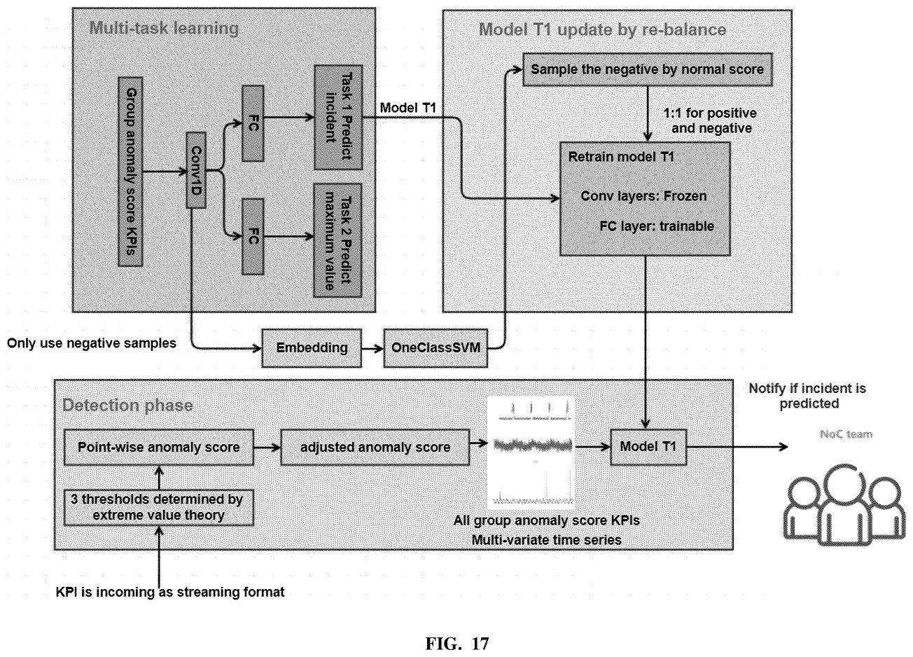

FIG. 18 is a block diagram showing exemplary apparatuses suitable for practicing the reception apparatus, according to embodiments of the disclosure.

As shown in FIG. 18, the apparatus 180 for analysing service performance data may comprise: a processor 1801; and a memory 1802. The memory 1802 contains instructions executable by the processor 1801, whereby the apparatus is operative for: obtaining a plurality of points of data for a key performance indicator, KPI; modelling the plurality of points, with generalized Pareto distribution, GPD; calculating at least one threshold for distinguishing extreme values of the plurality of points, based at least on one or more distribution parameters of the plurality of points and a probability parameter; and determining a plurality of anomaly scores for the plurality of points, based on a comparison of each of the plurality of the points to the at least one threshold.

Further, the apparatus 180 may be operative to perform the method according to any of the above embodiments, such as these shown in FIG. 2A, 2B, 2C.

The processors 1801 may be any kind of processing component, such as one or more microprocessor or microcontrollers, as well as other digital hardware, which may include digital signal processors (DSPs), special-purpose digital logic, and the like. The memories 1802 may be any kind of storage component, such as read-only memory (ROM), random-access memory, cache memory, flash memory devices, optical storage devices, etc.

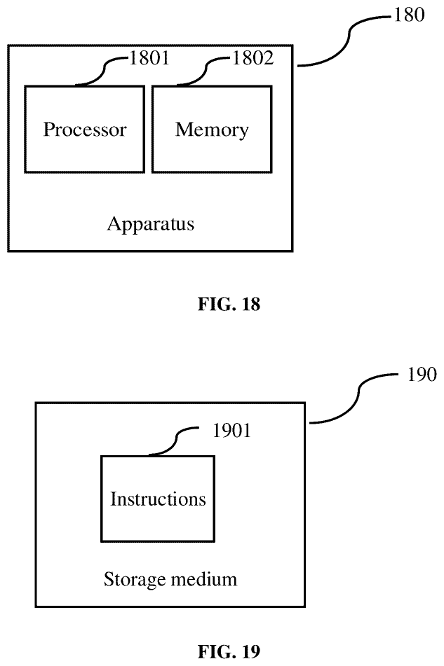

FIG. 19 is a block diagram showing an apparatus readable storage medium, according to embodiments of the present disclosure.

As shown in FIG. 19, the computer-readable storage medium 190, or any other kind of product, storing instructions 1901 which when executed by at least one processor, cause the at least one processor to perform the method according to any one of the above embodiments, such as these shown in FIG. 2A, 2B, 2C.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

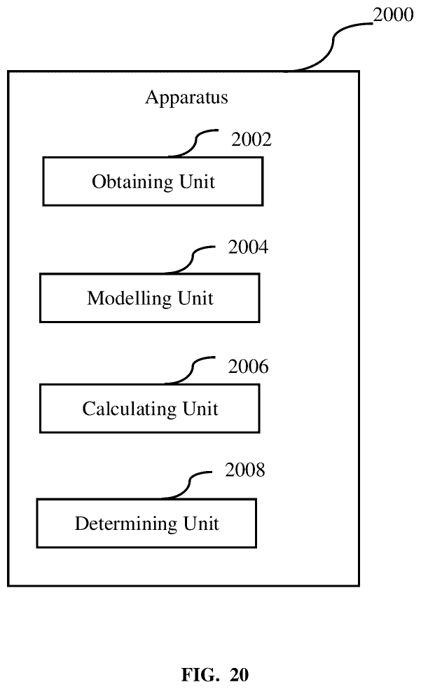

FIG. 20 is a schematic showing units for the apparatus, according to embodiments of the present disclosure.

In embodiments of the present disclosure, the apparatus 2000 may comprise: an obtaining unit 2002, configured for obtaining a plurality of points of data for a key performance indicator, KPI; a modelling unit 2004, configured for modelling the plurality of points, with generalized Pareto distribution, GPD; a calculating unit 2006, configured for calculating at least one threshold for distinguishing extreme values of the plurality of points, based at least on one or more distribution parameters of the plurality of points and a probability parameter; and a determining unit 2008, configured for determining a plurality of anomaly scores for the plurality of points, based on a comparison of each of the plurality of the points to the at least one threshold.

In embodiments of the present disclosure, the apparatus is further operative to perform the method according to any of embodiments above described, such as shown in FIG. 2A, 2B, 2C.

The term ‘unit’ may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With these units, the apparatus 2000 may not need a fixed processor or memory, any computing resource and storage resource may be arranged from at least one network node/device/entity/apparatus relating to the communication system. The virtualization technology and network computing technology (e.g. cloud computing) may be further introduced, so as to improve the usage efficiency of the network resources and the flexibility of the network.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Particularly, these function units may be implemented either as a network element on a dedicated hardware, as a software instance running on a dedicated hardware, or as a virtualized function instantiated on an appropriate platform, e.g. on a cloud infrastructure.

In general, the various exemplary embodiments of the present disclosure may be implemented in hardware or special purpose circuits, software, logic or any combination thereof. For example, some aspects may be implemented in hardware, while other aspects may be implemented in firmware or software that may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may include circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by those skilled in the art, the functionality of the program modules may be combined or distributed as desired in various embodiments. In addition, the functionality may be embodied in whole or in part in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

### ABBREVIATION EXPLANATION

MTBF Mean Time Between Failure
MIL Multi-instances learning
GPD Generalized Pareto Distribution
MLE Maximum likelihood
NOC Network Operations Center

### REFERENCES

The followings are the references which are incorporated herein in their entirety:
[1] Nengwen zhao et al., “Real-Time Incident Prediction for Online Service Systems”, ESEC/FSE 2020: Proceedings of the 28th ACM Joint Meeting on European Software Engineering Conference and Symposium on the Foundations of Software Engineering; November 2020; Pages 315-326; ISBN: 9781450370431; DOI: 10.1145/3368089
[2] ALBAN SIFFER, PIERRE-ALAIN FOUQUE, ALEXANDRE TERMIER, et al. Anomaly Detection in Streams with Extreme Value Theory [J]. KDD '17: The 23rd ACM SIGKDD International Conference on Knowledge Discovery and Data Mining Halifax NS Canada, Aug. 13-17, 2017. Pages 1067-1075, ISBN: 978-1-4503-4887-4; DOI: 10.1145/3097983.3098144.
[3] Multi-task Learning in Keras| Implementation of Multi-task Classification Loss, https://blog.manash.io/multi-task-learning-in-keras-implementation-of-multi-task-classification-loss-f1d42da5c3f6, Manash Kumar Mandal, Feb. 18, 2018
[4] Jawed, S., Grabocka, J., Schmidt-Thieme, L. (2020). Self-supervised Learning for Semi-supervised Time Series Classification. In: Lauw, H., Wong, R W., Ntoulas, A., Lim, E P., Ng, SK., Pan, S. (eds) Advances in Knowledge Discovery and Data Mining. PAKDD 2020. Lecture Notes in Computer Science( ), vol 12084. Springer, Cham.; ISBN978-3-030-47426-3; https://doi.org/10.1007/978-3-030-47426-3_39; 6 May 2020
[5] Introduction to One-class Support Vector Machines, http://rvlasveld.github.io/blog/2013/07/12/introduction-to-one-class-support-vector-machines, Roemer Vlasveld-Jul. 12, 2013
[6] Topic Model, https://en.wikipedia.org/wiki/Topic_model
[7] Boyan Zhou et al., “BBN: Bilateral-Branch Network with Cumulative Learning for Long-Tailed Visual Recognition”, March 2020, https://doi.org/10.48550/arXiv.1912.02413

1. A method for analysing service performance data, comprising:
obtaining a plurality of points of data for a key performance indicator, KPI;
modelling the plurality of points, with generalized Pareto distribution, GPD;
calculating at least one threshold for distinguishing extreme values of the plurality of points, based at least on one or more distribution parameters of the plurality of points and a probability parameter; and
determining a plurality of anomaly scores for the plurality of points, based on a comparison of each of the plurality of the points to the at least one threshold.

2. The method according to claim 1, wherein:
a plurality of values is configured for the probability parameter; and
the at least one threshold comprises a plurality of thresholds respectively corresponding to the plurality of values of the probability parameter.

3. The method according to claim 2, wherein;
a plurality of value scope is determined, based on the plurality of thresholds; and
an anomaly score for a point is determined based on a value scope that the point belongs to.

4. The method according to claim 3, further comprising:
adjusting the anomaly score for the point, based on one or more anomaly scores of one or more points around the point.

5. The method according to claim 4, wherein:
the anomaly score for the point is adjusted, based on a decay factor and a sum of the anomaly scores of one or more points before the point and of the point; and
the decay factor is determined based on whether an anomaly happens at the point, or the decay factor is determined based on whether an anomaly happens at a point before the point.

6. The method according to claim 5, wherein the decay factor is smaller when an anomaly happens at a point further away from the point.

7. The method according to claim 1, wherein the one or more distribution parameters of the plurality of points are calculated by using maximum likelihood estimation, MLE, and Grimshaw's law.

8. The method according to claim 1, further comprising:
summing anomaly scores of points with a same timestamp for more than one KPI in a group, at each timestamp, to obtain a plurality of group anomaly scores for the group.

9. The method according to claim 8, further comprising:
creating a sample including one or more groups for a learning machine, each group with a plurality of group anomaly scores;
wherein the sample is labelled as a first type or a second type, based on whether an event happens after the sample; and
wherein the first type is positive, and the second type is negative.

10. The method according to claim 9, further comprising:
training the learning machine with a plurality of labelled samples.

11. The method according to claim 10, wherein:
a first task of the learning machine is trained to predict whether an event will happen after an unlabeled sample; and/or
a second task of the learning machine is trained to predict a characteristic parameter of data after the unlabeled sample.

12. The method according to claim 11, wherein the learning machine comprises a neural network.

13. The method according to claim 12, wherein convolutional layers of the learning machine are frozen when training the first task and the second task.

14. The method according to claim 10, wherein:
a first number of labeled samples with the first type are used to train the learning machine; and
a first number of labeled samples with the second type are selected from a plurality of labeled samples with the second type, to be used to train the learning machine.

15. The method according to claim 14, wherein:
scores for ranking of the plurality of labeled samples with the second type are generated, by a one-class support vector method, OCSVM, based on embedding vectors outputted from convolutional layers of the learning machine; and
the first number of labeled samples with the second type are selected, based on the scores of the plurality of labeled samples with the second type.

16. The method according to claim 15, wherein:
a distribution scope of the scores of the plurality of labeled samples with the second type is divided into a plurality of sub scopes, based on appearance frequency of the scores;
a sub scope covering scores with lower appearance frequencies has a smaller size; and
the first number of labeled samples with the second type are selected from each sub scope averagely.

17. The method according to claim 1, wherein the service performance data is related to KPI data in algorithmic information technology operations, AIOps, or a sensor acquired data in a monitoring system.

18. An apparatus for analysing service performance data, comprising:
a processor; and
a memory containing instructions executable by the processor, whereby the apparatus is operative for:
obtaining a plurality of points of data for a key performance indicator, KPI;
modelling the plurality of points, with generalized Pareto distribution, GPD;
calculating at least one threshold for distinguishing extreme values of the plurality of points, based at least on one or more distribution parameters of the plurality of points and a probability parameter; and
determining a plurality of anomaly scores for the plurality of points, based on a comparison of each of the plurality of the points to the at least one threshold.

19. (canceled)
